(19) United States
(12) Patent Application Publication
(10) Pub. No.: US 2021/0200048 A1
(43) Pub. Date: Jul. 1, 2021

(54) ACTIVE SWITCH ARRAY SUBSTRATE, DISPLAY APPARATUS USING SAME, AND MANUFACTURING METHOD THEREFOR

(71) Applicant: HKC Corporation Limited, Shenzhen City, Guangdong (CN)

(72) Inventor: Beizhou HUANG, Shenzhen City, Guangdong (CN)

(21) Appl. No.: 16/068,520

(22) PCT Filed: Jan. 24, 2018
(86) PCT No.: PCT/CN2018/073936

§ 371 Date: Jul. 6, 2018

(30) Foreign Application Priority Data
Nov. 3, 2017 (CN) 201711071327.8

(51) Int. Cl. G02F 1/1362; G02F 1/1368

(52) U.S. Cl. CPC G02F 1/136295; G02F 1/136222; G02F 1/1368

(57) ABSTRACT

An active switch array substrate, and a manufacturing method therefor, including: a first substrate; a plurality of gate lines, formed on the first substrate; a gate cover layer, formed on the first substrate and covering the gate lines; a plurality of data lines, formed on the gate cover layer; a plurality of common electrodes, formed on the first substrate; a first passivation layer, formed on the gate cover layer and covering the data lines; a plurality of charge sharing units, where each charge sharing unit includes a capacitance sharing structure, the capacitance sharing structure includes a first conducting layer and a second conducting layer; the first passivation layer is located between the first conducting layer and the second conducting layer; a second passivation layer, covering the first conducting layer; and a pixel electrode layer, formed on the first passivation layer and the second passivation layer.

### BACKGROUND

### Technical Field

This application relates to a design method for alleviating color cast, and in particular, to an active switch array substrate, a display apparatus using same, and a manufacturing method therefor.

### Related Art

Generally, a liquid crystal display panel is formed by a color filter (CF), a thin film transistor array substrate (TFT Array Substrate), and a liquid crystal layer (LC Layer) disposed between the two substrates. A working principle of the liquid crystal display panel is that rotation of liquid crystal molecules of the liquid crystal layer are controlled by applying a driving voltage to two glass substrates, and light rays of a backlight module are refracted to generate an image. According to different orientation manners of liquid crystals, liquid crystal display panels on the current mainstream market may be classified into the following types: a vertical alignment (VA) type, a twisted nematic (TN) type, a super twisted nematic (STN) type, an in-plane switching (IPS) type, and a fringe field switching (FFS) type.

A liquid crystal display of a VA mode includes, for example, a patterned vertical alignment (PVA) liquid crystal display or a multi-domain vertical alignment (MVA) liquid crystal display apparatus. The PVA liquid crystal display achieves a wide-angle view by using a fringing field effect and a compensation plate. The MVA liquid crystal display apparatus divides one pixel into a plurality of regions, and makes, by using a protrusion or a particular pattern structure, the liquid crystal molecules in different regions tilt towards different directions, to achieve the wide-angle view and improve a transmittance.

In an IPS mode and an FFS mode, the liquid crystal molecules are in a direction parallel to a substrate plane by adding an electric field enough to be basically parallel to the substrate so as to correspondingly drive the liquid crystal molecules. Both an IPS liquid crystal display panel and an FFS liquid crystal display panel have an advantage of the wide-angle view. However, compared with a red light and a green light, a blue light has a relatively short wavelength, so the blue light needs a smaller retardation to reach a same transmittance. Curves of voltage-transmittance (V-T) of the red light, the green light, and the blue light are different. Moreover, in the panel, the red light, the green light, and the blue light have different transmittances in a polyimide (PI) film, a planarization layer (PFA), an over coating layer (OC), or the like, resulting in color cast.

In an MVA mode, the current mainstream is mostly dividing a pixel region into a bright region and a dark region. Therefore, two types of V-T features may be mixed in optical representation. In addition, an area ratio of the bright region to the dark region is properly adjusted. Therefore, a problem of grayscale washout under a large visual angle can be effectively suppressed.

Currently, another way to resolve a color cast problem is to adopt a conception of charge sharing. A charge sharing method is a technology of using capacitance sharing to implement redistribution of charge in a main/sub pixel region, thereby improving the color cast problem existed in a traditional VA display. Currently, a mainstream technology of resolving color cast is applied to various manufacturers. An advantage of the technology is greatly improving the color cast, but a disadvantage of the technology is that a design for an electrode in the pixel is relatively complex, indirectly affecting a design of an aperture ratio.

### SUMMARY

To resolve the foregoing technical problem, an objective of this application is to provide a design method for improving color cast, and in particular, to an active switch array substrate, a display apparatus using same, and a manufacturing method therefor, effectively resolving a color cast problem and improving an aperture ratio of pixel design.

The objective of this application is achieved and the technical problem of this application is resolved by using the following technical solutions. An active switch array substrate provided according to this application includes: a first substrate; a plurality of gate lines, formed on the first substrate; a gate cover layer, formed on the first substrate and covering the gate lines; a plurality of data lines, formed on the gate cover layer, where the data lines and the gate lines define a plurality of pixel regions; a plurality of common electrodes, formed on the first substrate, where the common electrodes are located at a border of the pixel regions and are adjacent to the gate lines, and the common electrodes and the gate lines are in a same layer; a first passivation layer, formed on the gate cover layer and covering the data lines; a plurality of charge sharing units, electrically coupled to the common electrodes and separately disposed in the pixel regions, where each charge sharing unit includes a capacitance sharing structure, the capacitance sharing structure includes a first conducting layer and a second conducting layer, the first conducting layer is made of a transparent conductive material, and a material of the second conducting layer is the same as a material of the data lines; and the first passivation layer is located between the first conducting layer and the second conducting layer; a second passivation layer, covering the first conducting layer; and a pixel electrode layer, formed on the first passivation layer and the second passivation layer.

The objective of this application may further be achieved and the technical problem of this application may further be implemented by using the following technical measure.

A manufacturing method for an active switch array substrate includes: providing a first substrate; forming a plurality of gate lines on the first substrate; forming a gate cover layer on the first substrate and covering the gate lines; forming a plurality of data lines and second conducting layers on the gate cover layer, where the data lines and the gate lines define a plurality of pixel regions; forming a first passivation layer on the gate cover layer and covering the data lines and the second conducting layers; forming a plurality of first conducting layers on the first passivation layer, where the first conducting layers are made of a transparent conductive material, a material of the second conducting layers is the same as a material of the data lines, the first passivation layer is located between the first conducting layers and the second conducting layers, and the first conducting layers and the second conducting layers are separately combined to be a plurality of capacitance sharing structures; covering the first conducting layer with a second passivation layer; and forming a pixel electrode layer on the first passivation layer and the second passivation layer.

A liquid crystal display panel includes: an active switch array substrate as described, a color filter layer substrate disposed opposite to the active switch array substrate, and a liquid crystal layer formed between the active switch array substrate and the color filter layer substrate.

A liquid crystal display apparatus includes a backlight module and the liquid crystal display panel.

In an embodiment of this application, in the active switch array substrate, the transparent conductive material is an indium tin oxide.

In an embodiment of this application, in the active switch array substrate, a film thickness of the first passivation layer is 0.1 μm.

In an embodiment of this application, in the active switch array substrate, the second passivation layer has a step-shaped profile.

In an embodiment of this application, in the manufacturing method, the second passivation layer has a step-shaped profile, and a photomask is a gray-tone mask or a half tone mask.

In an embodiment of this application, in the manufacturing method, a plurality of data lines and second conducting layers are simultaneously formed on the gate cover layer.

In an embodiment of this application, in the liquid crystal display panel, the second passivation layer has a step-shaped profile.

A beneficial effect of this application is effectively resolving a color cast problem of the liquid crystal display panel and improving an aperture ratio and a transmittance of pixel design

### BRIEF DESCRIPTION OF THE DRAWINGS

FIG. 1 is a circuit diagram of an exemplary liquid crystal pixel for resolving a color cast problem;

FIG. 1a is another circuit diagram of an exemplary liquid crystal pixel for resolving a color cast problem;

FIG. 1b is a schematic diagram displaying an exemplary voltage energy level of a sub pixel;

FIG. 2a is a schematic diagram of a pixel structure of an exemplary charge sharing unit;

FIG. 2b is a schematic diagram of an exemplary charge sharing unit;

FIG. 2c is a cross-section structural diagram of an exemplary charge sharing unit;

FIG. 3 is a schematic structural diagram of a first substrate according to an embodiment of this application;

FIG. 4 is a schematic diagram of a pixel structure of a charge sharing unit according to an embodiment of this application;

FIG. 4a is a schematic diagram of a charge sharing unit according to an embodiment of this application;

FIG. 4b is a cross-section structural diagram of a charge sharing unit according to an embodiment of this application;

FIG. 4c is a schematic diagram of a pixel structure having a half tone mask according to an embodiment of this application;

FIG. 4d is a schematic diagram of a pixel structure manufactured by using a gray-tone mask or a half-tone mask process and having a surface with gradients according to an embodiment of this application;

FIG. 4e is a schematic diagram of a pixel structure manufactured by using a half-tone process and having a surface with gradients according to another embodiment of this application;

FIG. 4f is a schematic diagram of a pixel structure manufactured by using a half-tone process and having a surface with gradients according to still another embodiment of this application; and

FIG. 4g is a schematic diagram of a pixel structure manufactured by using a half-tone process and having a surface with gradients according to yet another embodiment of this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical means adopted in this application to achieve a predetermined invention objective and effects of this application, specific implementations, structures, features, and effects of an active switch array substrate, a display apparatus using same, and a manufacturing method therefor provided according to this application are described in detail below with reference to the accompanying drawings and preferred embodiments.

A liquid crystal display apparatus of this application may include a backlight module and a liquid crystal display panel. The liquid crystal display panel may include: a thin film transistor (TFT) substrate, a color filter (CF) substrate, and a liquid crystal layer formed between the two substrates.

In an embodiment, the liquid crystal display panel of this application may be a curved display panel, and the liquid crystal display apparatus of this application may also be a curved display apparatus.

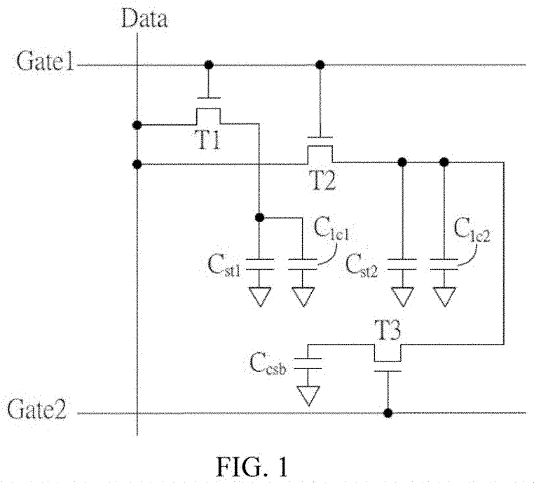

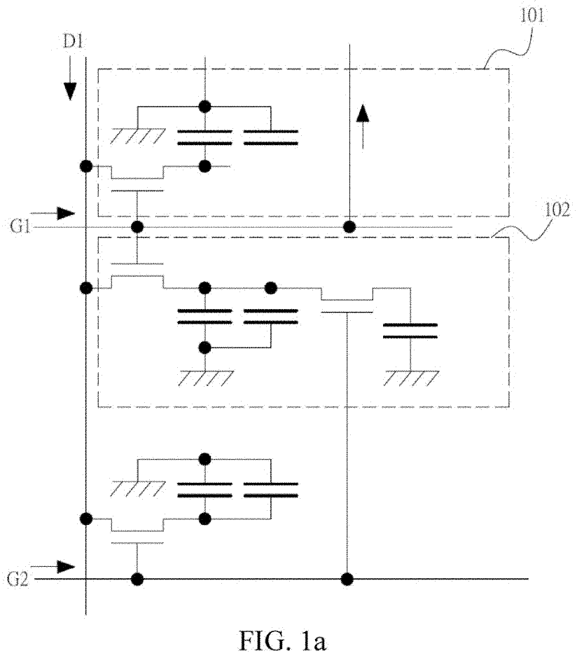

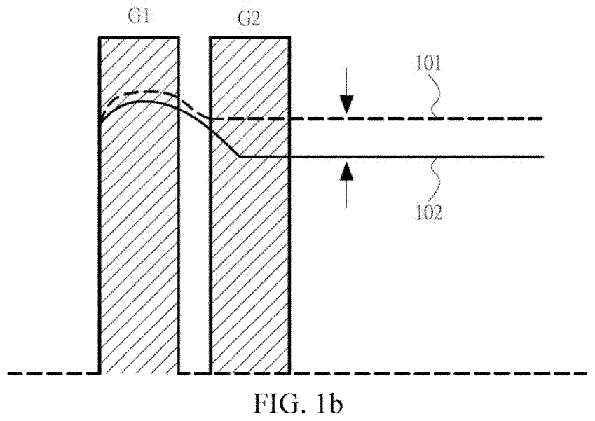

FIG. 1 is a circuit diagram of an exemplary liquid crystal pixel for resolving a color cast problem. In the liquid crystal display, to make a plurality of electrodes in the pixel perform charge sharing between each other is a technology derived for resolving the color cast problem. Referring to FIG. 1, a liquid crystal pixel circuit as shown in FIG. 1, a main pixel is controlled by a gate line Gate1, and a transistor T₁ is used to obtain data from a data line Data and store the data in a storage capacitance Cₛₜ₁; a sub pixel is also controlled by the gate line Gate1, and a transistor T₂ is used to obtain data from the data line Data and store the data in a storage capacitance Cₛₜ₂, apart from that, the sub pixel is further controlled by a gate line Gate2, and a transistor T₃ is used to perform charge sharing between a storage capacitance Cₛₜ₂ and a storage capacitance C_{csb}. Under this structure, the liquid crystal pixel circuit as shown in FIG. 1 may appropriately control a ratio of a voltage stored in the storage capacitance Cₛₜ₁ and the storage capacitance Cₛₜ₂, so that liquid crystal capacitances C_{1c1} and C_{1c2} are driven by a default voltage to resolve the color cast problem during displaying. However, with the update of technologies, the resolution and image updating frequency of liquid crystal displays are accordingly improved. In this case, for each pixel circuit, a charge time when the data from the data line Data is stored in the storage capacitance Cₛₜ₁ and Cₛₜ₂ may be reduced no matter that more data in the pixel circuit needs to be updated in a same time because of an increase of the resolution, or that the original data in the pixel circuit must be updated in a shorter time because of an increase of the image updating frequency, or that more data in the pixel circuit needs to be updated in a shorter time because of an increase of the resolution and the image updating frequency. Once the charge time used by the pixel circuit is reduced, the storage capacitance Cₛₜ₁ and Cₛₜ₂ may not be completely charged, resulting in that the storage voltage of the storage capacitance Cₛₜ₁ and Cₛₜ₂ may not reach a same level. Once the storage voltages of the storage capacitances Cₛₜ₁ and Cₛₜ₂ are different, a ratio between a voltage maintained by the storage capacitance Cₛₜ₂ and a voltage maintained by the storage capacitance Cₛₜ₁ cannot reach a preset proportion after the storage capacitance Cₛₜ₂ performs charge sharing with the storage capacitance C_{csb}. Therefore, the color cast problem to be resolved may still appear in the displaying process.

FIG. 1a is another circuit diagram of an exemplary liquid crystal pixel for resolving a color cast problem and FIG. 1b is a schematic diagram displaying an exemplary voltage energy level of a sub pixel. Referring to FIG. 1a and FIG. 1b, a current charge sharing method is a technology of using capacitance sharing to implement redistribution of charge in a main pixel region 101 and a sub pixel region 102, thereby resolving the color cast problem existed in a traditional VA display. An advantage of the technology is greatly improving the color cast, but a disadvantage of the technology is that a design for an electrode in the pixel is relatively complex, indirectly affecting a design of an aperture ratio.

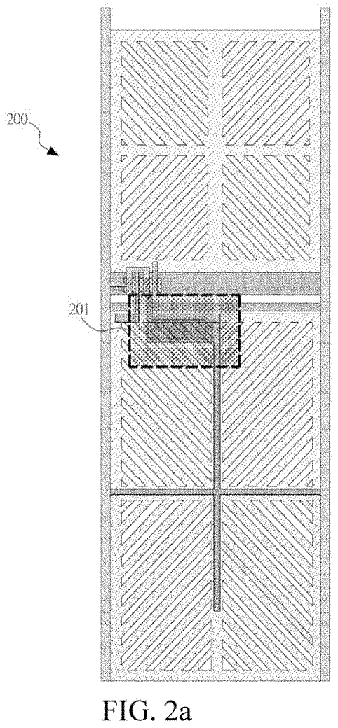

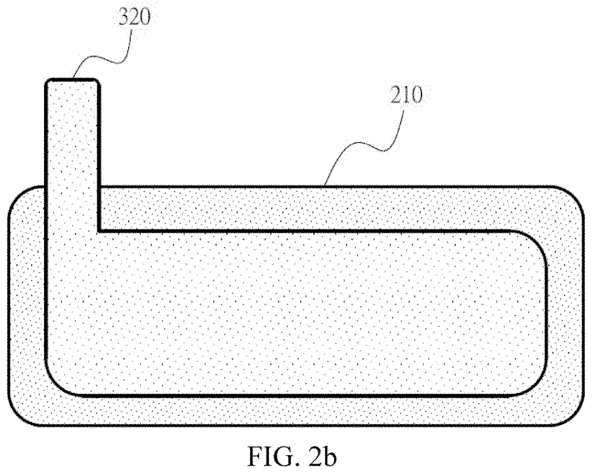

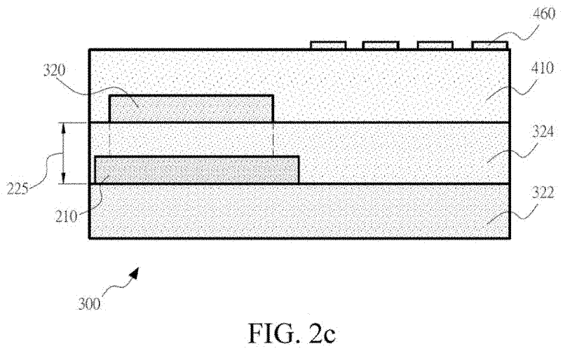

FIG. 2a is a schematic diagram of a pixel structure of an exemplary charge sharing unit, FIG. 2b is a schematic diagram of an exemplary charge sharing unit, and FIG. 2c is a cross-section structural diagram of an exemplary charge sharing unit. Referring to FIG. 2a, FIG. 2b, and FIG. 2c, a pixel structure of a charge sharing unit includes: a first substrate 300, including a first substrate 322; a plurality of data lines 320, formed on the first substrate 322; a plurality of gate lines 210, formed on the first substrate 322, where the plurality of data lines 320 and the plurality of gate lines 210 define a plurality of pixel regions 200; a gate cover layer 324, formed on the first substrate 322, where a film thickness 225 of the gate cover layer 324 is 3.5 μm; a passivation layer 410, formed on the gate cover layer 324, where a pixel electrode 460 is disposed above the passivation layer 410; and a charge sharing unit 201, electrically coupled to the plurality of gate lines 210.

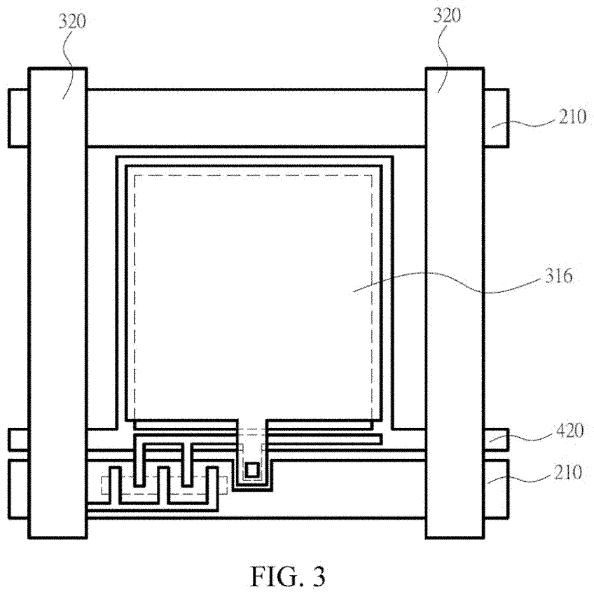

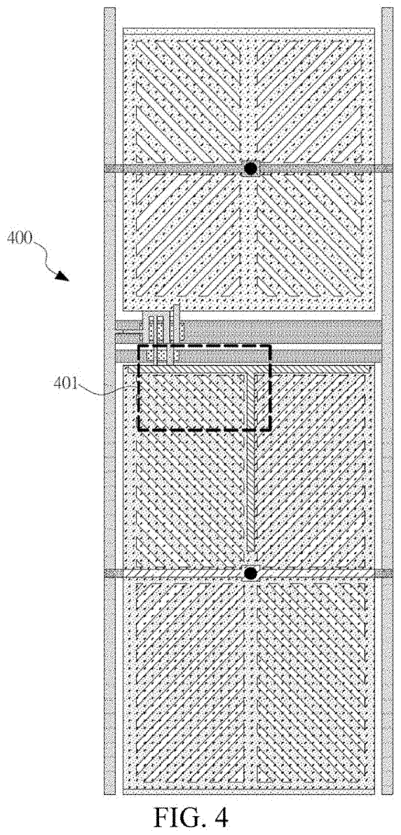

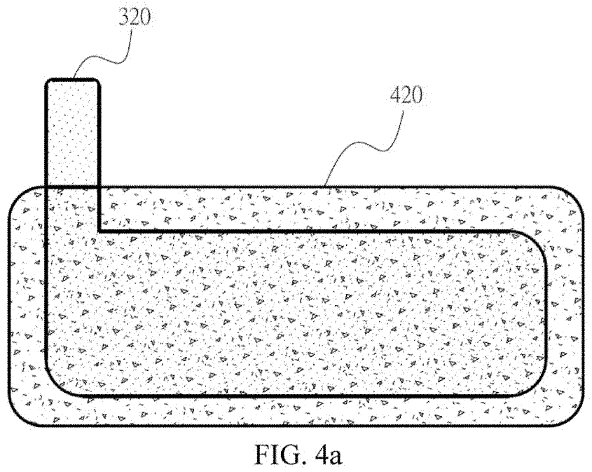

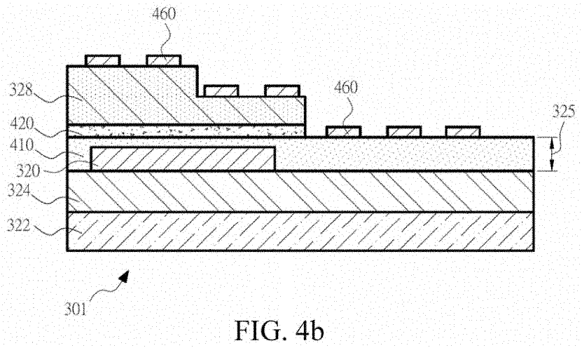

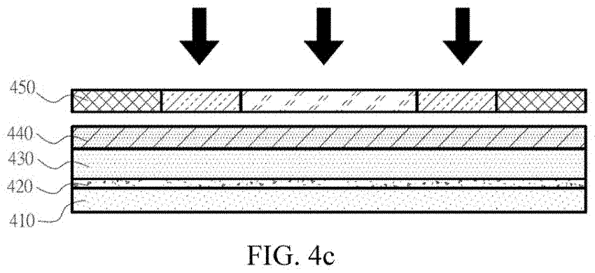

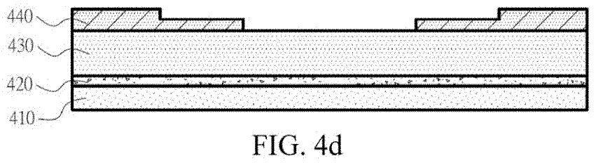

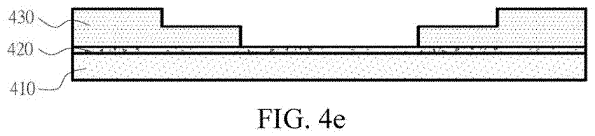

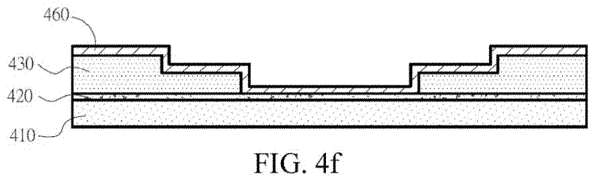

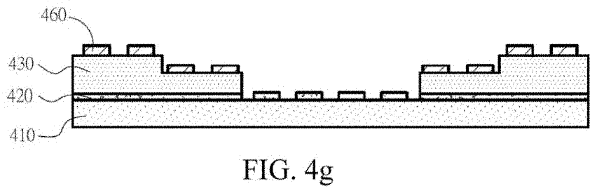

FIG. 3 is a schematic structural diagram of a first substrate 301 according to an embodiment of this application. FIG. 4 is a schematic diagram of a pixel structure of a charge sharing unit 401 according to an embodiment of this application, FIG. 4a is a schematic diagram of a charge sharing unit 401 according to an embodiment of this application, and FIG. 4b is a cross-section structural diagram of a charge sharing unit 401 according to an embodiment of this application. Referring to FIG. 3, FIG. 4, FIG. 4a, and FIG. 4b, in an embodiment of this application, an active switch array substrate 301 includes: a first substrate 322; a plurality of gate lines 210, formed on the first substrate 322; a gate cover layer 324, formed on the first substrate 322 and covering the gate lines 210; a plurality of data lines 320, formed on the gate cover layer 324, where the plurality of data lines 320 and the plurality of gate lines 210 define a plurality of pixel regions 316; a plurality of common electrodes 420 (for example, indium tin oxide electrodes), formed on the first substrate 322, where the common electrodes 420 are located at a border of the pixel regions 316 and are adjacent to the gate lines 210, and the common electrodes and the gate lines are in a same layer; a first passivation layer 410, formed on the gate cover layer 324 and covering the data lines 320, where a film thickness 325 of the first passivation layer 410 is 0.1 μm; a plurality of charge sharing units 401, electrically coupled to the common electrodes 420 and separately disposed in the pixel regions 400, where each charge sharing unit 401 includes a capacitance sharing structure, the capacitance sharing structure includes a first conducting layer 420 and a second conducting layer 320, the first conducting layer 420 is made of a transparent conductive material, and a material of the second conducting layer 320 is the same as a material of the data lines 320; and the first passivation layer 410 is located between the first conducting layer 420 and the second conducting layer 320; a second passivation layer 328, covering the first conducting layer 420, where the second passivation layer 328 has a step-shaped profile; and a pixel electrode layer 460, formed on the first passivation layer 410 and the second passivation layer 328.

Referring to FIG. 3, FIG. 4, FIG. 4a, and FIG. 4b, in an embodiment of this application, a liquid crystal display panel of this application includes: an active switch array substrate 301, including: a first substrate 322; a plurality of gate lines 210, formed on the first substrate 322; a gate cover layer 324, formed on the first substrate 322 and covering the gate lines 210; a plurality of data lines 320, formed on the gate cover layer 324, where the plurality of data lines 320 and the plurality of gate lines 210 define a plurality of pixel regions 316; a plurality of common electrodes 420 (for example, indium tin oxide electrodes), formed on the first substrate 322, where the common electrodes 420 are located at a border of the pixel regions 316 and are adjacent to the gate lines 210, and the common electrodes and the gate lines are in a same layer; a passivation layer 410, formed on the gate cover layer 324 and covering the data lines 320, where a film thickness 325 of the passivation layer 410 is 0.1 μm; a plurality of charge sharing units 401, electrically coupled to the common electrodes 420 and separately disposed in the pixel regions 400, where each charge sharing unit 401 includes a capacitance sharing structure, the capacitance sharing structure includes a first conducting layer 420 and a second conducting layer 320, the first conducting layer 420 is made of a transparent conductive material, and a material of the second conducting layer 320 is the same as a material of the data lines 320; and the first passivation layer 410 is located between the first conducting layer 420 and the second conducting layer 320; a second passivation layer 328, covering the first conducting layer 420, where the second passivation layer 328 has a step-shaped profile; and a pixel electrode layer 460, formed on the first passivation layer 410 and the second passivation layer 328; a second substrate (not shown in figures) (for example, a color filter layer substrate), where the active switch array substrate 301 is disposed opposite to the second substrate (not shown in figures); and a liquid crystal layer, formed between the active switch array substrate 301 and the second substrate (not shown in figures), where the liquid crystal layer includes an optical activity substance.

In an embodiment of this application, a liquid crystal display apparatus of this application includes a backlight module and a liquid crystal display panel, where the liquid crystal display panel includes an active switch array substrate 301, including: a first substrate 322; a plurality of gate lines 210, formed on the first substrate 322; a gate cover layer 324, formed on the first substrate 322 and covering the gate lines 210; a plurality of data lines 320, formed on the gate cover layer 324, where the plurality of data lines 320 and the plurality of gate lines 210 define a plurality of pixel regions 316; a plurality of common electrodes 420 (for example, indium tin oxide electrodes), formed on the first substrate 322, where the common electrodes 420 are located at a border of the pixel regions 316 and are adjacent to the gate lines 210, and the common electrodes and the gate lines are in a same layer; a first passivation layer 410, formed on the gate cover layer 324 and covering the data lines 320, where a film thickness 325 of the first passivation layer 410 is 0.1 μm; a plurality of charge sharing units 401, electrically coupled to the common electrodes 420 and separately disposed in the pixel regions 400, where each charge sharing unit 401 includes a capacitance sharing structure, the capacitance sharing structure includes a first conducting layer 420 and a second conducting layer 320, the first conducting layer 420 is made of a transparent conductive material, and a material of the second conducting layer 320 is the same as a material of the data lines 320; and the first passivation layer 410 is located between the first conducting layer 420 and the second conducting layer 320; a second passivation layer 328, covering the first conducting layer 420, where the second passivation layer 328 has a step-shaped profile; and a pixel electrode layer 460, formed on the first passivation layer 410 and the second passivation layer 328; a second substrate (not shown in figures) (for example, a color filter layer substrate), where the active switch array substrate 301 is disposed opposite to the second substrate (not shown in figures); and a liquid crystal layer, formed between the active switch array substrate 301 and the second substrate (not shown in figures), where the liquid crystal layer includes an optical activity substance.

Referring to FIG. 4 and FIG. 4b, in an embodiment, the charge sharing unit 401 of this application is disposed between an indium tin oxide pixel electrode 460 and an indium tin oxide common electrode 420, so that a needed design area to obtain a same capacitance value may reduce two-thirds, thereby simplifying a pixel edge design.

Referring to FIG. 2c and FIG. 4b, in an embodiment, compared with the substrate 300 that does not include the indium tin oxide common electrode 420, a transmittance aperture ratio of the active switch array substrate 301 of this application may improve about 3% to 10%.

FIG. 4c is a schematic diagram of a pixel structure having a half tone mask according to an embodiment of this application. Referring to FIG. 4b and FIG. 4c, in an embodiment of this application, the first substrate 301 has four structures, including: a first passivation layer 410, an indium tin oxide common electrode (ITO COM) layer 420, a second passivation layer 430, and a photoresist material layer 440. In addition, steps such as film formation, exposure, developing, etching, and stripping of membrane are needed to accomplish the first substrate (for example, the active switch array substrate) 301.

FIG. 4d is a schematic diagram of a pixel structure manufactured by using a gray-tone mask or a half-tone mask process and having a surface with gradients according to an embodiment of this application, FIG. 4e is a schematic diagram of a pixel structure manufactured by using a half-tone process and having a surface with gradients according to another embodiment of this application, FIG. 4f is a schematic diagram of a pixel structure manufactured by using a half-tone process and having a surface with gradients according to still another embodiment of this application, and FIG. 4g is a schematic diagram of a pixel structure manufactured by using a half-tone process and having a surface with gradients according to yet another embodiment of this application. Referring to FIG. 4c, FIG. 4d, FIG. 4e, FIG. 4f, and FIG. 4g, in an embodiment of this application, the film formation step is covering a film of required materials (a gate cover layer 324, a first passivation layer 410, an indium tin oxide common electrode layer 420, a second passivation layer 430, a photoresist material layer 440, and an indium tin oxide pixel electrode layer 460) on a glass substrate 322; the exposure step is developing a needed pattern of a photoresist 440 on a photoresist 440 by using a photomask 450; the developing step is retaining a patterned portion of the photoresist 440 of the upper stage photoresist 440; the etching step is etching a needed pattern on the substrate 322 that already has the pattern of the photoresist 440; the stripping of membrane step is removing the photoresist 440 covering on the image to perform a next procedure by using the substrate 322 already etched with the needed pattern.

Referring to FIG. 3, FIG. 4b, FIG. 4c, FIG. 4d, FIG. 4e, FIG. 4f, and FIG. 4g, in an embodiment of this application, a manufacturing method for an active switch array substrate 301 includes: providing a first substrate 322; forming a plurality of gate lines 210 on the first substrate 322; forming a gate cover layer 324 on the first substrate 322 and covering the gate lines 210; forming a plurality of data lines 320 and second conducting layers 320 on the gate cover layer 324, where the data lines 320 and the gate lines 210 define a plurality of pixel regions 316; forming a first passivation layer 410 on the gate cover layer 324 and covering the data lines 320 and the second conducting layers 320; forming a plurality of first conducting layers 420 on the first passivation layer 410, where the first conducting layers 420 are made of a transparent conductive material, a material of the second conducting layers 320 is the same as a material of the data lines 320, the first passivation layer 410 is located between the first conducting layers 420 and the second conducting layers 320, and the first conducting layers 420 and the second conducting layers 320 are separately combined to be a plurality of capacitance sharing structures; covering the first conducting layer 420 with a second passivation layer 328; and forming a pixel electrode layer 460 on the first passivation layer 410 and the second passivation layer 328.

In an embodiment, in the manufacturing method of this application, the second passivation layer 328 has a step-shaped profile, where the second passivation layer 328 is simultaneously formed in a process of photoresist coating, exposure, developing, and a photomask, and the photomask 450 is a gray-tone mask or a half tone mask.

In an embodiment, in the manufacturing method of this application, simultaneously forming the plurality of data lines 320 and the second conducting layers 320 on the gate cover layer 324 in a process of photoresist coating, exposure, developing, a photomask, and etching.

A beneficial effect of this application is effectively resolving a color cast problem of the liquid crystal display panel and improving an aperture ratio and a transmittance of pixel design

Terms such as “in some embodiments” and “in various embodiments” are repeatedly used. Usually, the terms do not refer to a same embodiment; but they may also refer to a same embodiment. The words, such as “comprise”, “have”, and “include”, are synonyms, unless other meanings are indicated in the context thereof.

Descriptions above are merely preferred embodiments of this application, and are not intended to limit this application. Although this application has been disclosed above in forms of preferred embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. An active switch array substrate, comprising:
a first substrate;
a plurality of gate lines, formed on the first substrate;
a gate cover layer, formed on the first substrate and covering the gate lines;
a plurality of data lines, formed on the gate cover layer, wherein the data lines and the gate lines define a plurality of pixel regions;
a plurality of common electrodes, formed on the first substrate, wherein the common electrodes are located at a border of the pixel regions and are adjacent to the gate lines, and the common electrodes and the gate lines are in a same layer;
a first passivation layer, formed on the gate cover layer and covering the data lines;
a plurality of charge sharing units, separately disposed in the pixel regions and electrically coupled to the common electrodes, wherein each charge sharing unit comprises a capacitance sharing structure, and the capacitance sharing structure comprises a first conducting layer and a second conducting layer, and the first passivation layer is located between the first conducting layer and the second conducting layer;
a second passivation layer, covering the first conducting layer; and
a pixel electrode layer, formed on the first passivation layer and the second passivation layer.

2. The active switch array substrate according to claim 1, wherein the first conducting layer is made of a transparent conductive material.

3. The active switch array substrate according to claim 1, wherein a material of the second conducting layer is the same as a material of the data lines.

4. The active switch array substrate according to claim 2, wherein the transparent conductive material is an indium tin oxide.

5. The active switch array substrate according to claim 1, wherein a film thickness of the first passivation layer is 0.1 μm.

6. The active switch array substrate according to claim 1, wherein the second passivation layer has a step-shaped profile.

7. A manufacturing method for an active switch array substrate, comprising:
providing a first substrate;
forming a plurality of gate lines on the first substrate;
forming a gate cover layer on the first substrate and covering the gate lines;
forming a plurality of data lines and second conducting layers on the gate cover layer, wherein the data lines and the gate lines define a plurality of pixel regions;
forming a first passivation layer on the gate cover layer and covering the data lines and the second conducting layers;
forming a plurality of first conducting layers on the first passivation layer, wherein the first passivation layer is located between the first conducting layers and the second conducting layers, and the first conducting layers and the second conducting layers are separately combined to be a plurality of capacitance sharing structures;
covering the first conducting layer with a second passivation layer; and
forming a pixel electrode layer on the first passivation layer and the second passivation layer.

8. The active switch array substrate according to claim 7, wherein the first conducting layer is made of a transparent conductive material.

9. The active switch array substrate according to claim 7, wherein a material of the second conducting layer is the same as a material of the data lines.

10. The manufacturing method for the active switch array substrate according to claim 7, wherein the second passivation layer has a step-shaped profile, and a photomask is a grayscale photomask or a half tone mask.

11. The manufacturing method for the active switch array substrate according to claim 7, wherein the plurality of data lines and second conducting layers are simultaneously formed on the gate cover layer.

12. A liquid crystal display apparatus, comprising a backlight module and a liquid crystal display panel, wherein the liquid crystal display panel comprises:
an active switch array substrate, comprising:
a first substrate;
a plurality of gate lines, formed on the first substrate;
a gate cover layer, formed on the first substrate and covering the gate lines;
a plurality of data lines, formed on the gate cover layer, wherein the data lines and the gate lines define a plurality of pixel regions;
a plurality of common electrodes, formed on the first substrate, wherein the common electrodes are located at a border of the pixel regions and are adjacent to the gate lines, and the common electrodes and the gate lines are in a same layer;
a first passivation layer, formed on the gate cover layer and covering the data lines;
a plurality of charge sharing units, separately disposed in the pixel regions and electrically coupled to the common electrodes, wherein each charge sharing unit comprises a capacitance sharing structure, the capacitance sharing structure comprises a first conducting layer and a second conducting layer, the first conducting layer is made of a transparent conductive material, and a material of the second conducting layer is the same as a material of the data lines; and the first passivation layer is located between the first conducting layer and the second conducting layer;
a second passivation layer, covering the first conducting layer; and
a pixel electrode layer, formed on the first passivation layer and the second passivation layer;
a color filter layer substrate, disposed opposite to the active switch array substrate; and
a liquid crystal layer, formed between the active switch array substrate and the color filter layer substrate.

13. The liquid crystal display apparatus according to claim 12, wherein the transparent conductive material is an indium tin oxide.

14. The liquid crystal display apparatus according to claim 12, wherein a film thickness of the first passivation layer is 0.1 μm.

15. The liquid crystal display apparatus according to claim 12, wherein the second passivation layer has a step-shaped profile.
